(19) United States
(12) Patent Application Publication
(10) Pub. No.: US 2025/0171064 A1
(43) Pub. Date: May 29, 2025

(54) CAM FOLLOWER ASSEMBLY AND DRAGGING EQUIPMENT DETECTION SYSTEM INCLUDING THE SAME

(71) Applicant: voestalpine SIGNALING Siershahn GmbH, Siershahn (DE)

(72) Inventor: Daniel KESSLER, Daaden (DE)

(21) Appl. No.: 18/840,571

(22) PCT Filed: Mar. 18, 2022
(86) PCT No.: PCT/EP2022/057167

§ 371 Date: Aug. 22, 2024

(51) Int. Cl. B61L 27/57; B61L 1/20; G01L 5/00

(52) U.S. Cl. CPC B61L 27/57; B61L 1/20; G01L 5/0052

(57) ABSTRACT

A cam follower assembly (100) for a dragging equipment detection system comprising: one of a cam (130) or a cam follower (140) adapted to be drivably connected to an impact element (200) of a dragging equipment detection system so as to move together with the impact element (200) upon reception of an impact. The cam (130) includes a cam surface (131). The cam follower (140) includes a follower element (141) and a spring (142) configured to bias the follower element (141) against the cam surface (131) of the cam (130) with a bias force. The cam follower (140) and the cam (130) are adapted to move relative to each other, while one of the cam follower (140) and the cam (130) is fixed and the other is movable. At least one of the cam surface (131) and the follower element (141) comprise a variable effective shape.

### TECHNICAL FIELD

The present disclosure relates to a cam follower assembly. Such a cam follower assembly is, inter alia, suited for use in a dragging equipment detection-DED-system used to detect an object hanging below a moving train.

### BACKGROUND

When a train travels on the train tracks, parts of the train or train equipment (such as couplings, chains, hoses, or pneumatic tubes on a train) may hang down from the train. This can cause damages to these parts or to equipment on the train track or pose a danger to humans alongside the track.

A dragging equipment detection system is provided to protect humans alongside the track and protect fixed assets such as switches, crossings, or signals against these kind of damages. When components are being dragged with a train, the DED system generates an alarm to traffic control or to the train driver in real-time to limit consequential damages. Alarms are generated at user-defined tolerance levels. The system provides information about the position of the dragging equipment at the train.

In the conventional art (as disclosed in U.S. Pat. No. 2,677,048 A, U.S. Pat. No. 7,292,144 B2 and U.S. Pat. No. 8,922,384 B2), a dragging equipment detection system is designed to reliably detect parts hanging down from a train. Typically, a dragging equipment detection system includes a mechanical structure fixed on a sleeper (wood, concrete, steel), consisting of a rigid part. A movable part is mounted transversely to the direction of train rails and is arranged to rotate or tilt with respect to the rigid mechanical structure when receiving an impact from a part hanging down from a moving train. When a part hanging down from a moving train strikes this movable part, the movable part of the dragging equipment detection system rotates or tilts by a certain angle in the traveling direction of the train. A sensor then detects a movement of the movable part and triggers an alarm or provides a signal indicating the movement to a monitoring device. The movable part to which the sensor can be attached constitutes a cam follower assembly.

U.S. Pat. No. 7,292,144 B2 refers to an apparatus and method for use with a railroad dragging equipment detecting system. A generator supplies a first signal and is coupled to a magnetic amplifier coil to form a magnetically variable impedance circuit. The magnetic amplifier coil is responsive to the first signal to create a circuit impedance in series with a detection circuit. A magnet is mechanically connected to the cam/follower system and is positioned near the magnetic amplifier core for varying a circuit impedance of the detection circuit. A detection circuit generates a second signal as a function of variations in circuit impedance. A controller is responsive to the second signal for activating an alarm when the magnet moves relative to the magnetic amplifier coil.

The conventional art also includes an electronic dragging equipment detection system, which uses accelerometers to measure an impact of a part hanging down from a moving train on a non-movable object mounted on the train track. Because of the electronic evaluation and the absence of movable parts, these systems can be more flexible and may offer greater possibilities for evaluation and alarm generation. However, an electronic dragging equipment detection system requires a power supply and is subject to electromagnetic interference due to lightning/over-voltage. Further, an electronic dragging equipment detection system usually has a high false alarm rate due to the difficulty in distinguishing between impacts and vibrations in the track (especially, flat spots on wheels may generate signals that are very similar to impacts).

In a mechanical dragging equipment detection system of the conventional art, the movable part can be plates or so-called paddles that are usually hit by parts hanging down from a moving train. A mechanical impact on the paddles causing a torque on the shaft is required to move the paddles. A breakaway torque of the shaft makes sure that the paddles are not moved by the wind draft or the vibrations of a passing train alone triggering false alarm, as will be explained below with reference to FIG. 6.

FIG. 6 illustrates a prior art cam follower assembly for a dragging equipment detection system. The cam follower assembly, as shown in FIG. 6, includes a cam 1 and a follower 2. The cam 1 includes a curved surface 4 facing the follower 2, which includes a follower element 3 in contact with the curved surface 4. The follower 2 further includes a spring configured to bias the follower element 3 against the cam 1 to maintain a contact between the follower element 3 and the curved surface 4. As can be seen in FIG. 6, the curved surface 4 has an indentation 5.

In use, the cam 1 is fixed to the shaft of the dragging equipment detection system to rotate together with the paddles. At a rest position of the cam 1, the paddles are in a vertically upward orientation/position and the follower element 3 is received in the indentation 5. When the paddles and the cam 1 are to rotate (for example, due to an impact on the paddles by a part hanging down from a moving train), since the follower element 3 is received in the indentation 5, the cam 1 and the paddles have to overcome a breakaway torque so as to rotate away from the rest position such that the follower element 3 is no longer received in the indentation 5 (as the state shown in FIG. 6).

After an impact, in some cases, the paddles have to be returned to their original position or rest position by hand after each release. In other cases, the dragging equipment detection system may include a torsion bar or springs providing a restoring torque to the shaft with paddles so that the paddles can automatically return to their rest position after the impact. The movement of the paddles from the rest position is detected by mechanical or electronic switches and converted into an electrical signal, which may then be used to trigger an alarm signaling the occurrence of impact and the existence of a part hanging down from a moving train.

The breakaway torque required to rotate or tilt the paddles and trigger an alarm can vary depending on the requirements of the railroad or infrastructure operator. For example, a slow-moving train generates a lower impact than a fast-moving train when a drooping part hits the paddle. Similarly, air hoses weighing 3 kg generate significantly lower forces than clutch chains weighing 20 kg as a part hanging down from a moving train. Depending on the application, the movable part of the dragging equipment detection system has to provide different breakaway torque settings.

Further technological background may be found in U.S. Pat. No. 10,196,078 B, US 2017 151,970 A, US 2014 110,536 A, US 2014 110,535 A, US 2014 118,152 A, US 2014 110,534 A, US 2005 110,482 A, US 2009 057,495 A, US 1999 386,202 A, US 1968 787,849 A, U.S. Pat. No. 3,325,640 A, U.S. Pat. No. 2,993,988 A, U.S. Pat. No. 2,896,069 A, U.S. Pat. No. 2,848,602 A, U.S. Pat. No. 2,691,722 A, U.S. Pat. No. 2,662,973 A, U.S. Pat. No. 2,581,084 A U.S. Pat. No. 2,435,365 A, U.S. Pat. No. 2,435,365 A, U.S. Pat. No. 2,401,501 A, U.S. Pat. No. 2,128,373 A, BE 420 391 A, U.S. Pat. No. 2,021,568 A.

Therefore, there is a need for a low-cost, precise, and high-efficient way of adjusting and maintaining a stable breakaway torque required to rotate the paddles and trigger an alarm for a dragging equipment detection system.

### SUMMARY

An object of the present disclosure is thus to provide a cam follower assembly for a dragging equipment detection system for resolving the above problems of the conventional art. A further object is the reliable returning of the DED system into its rest position.

In an aspect, the present disclosure provides a cam follower assembly as defined in claim 1, for a dragging equipment detection system as defined in claim 14.

The cam follower assembly may comprise a cam follower assembly for a dragging equipment detection system comprising: one of a cam or a cam follower adapted to be drivably connected to an impact element of a dragging equipment detection system so as to move together with the impact element upon reception of an impact. The cam includes a cam surface. The cam follower includes a follower element and a spring configured to bias the follower element against the cam surface of the cam with a bias force. The cam follower and the cam are adapted to move relative to each other, while one of the cam follower and the cam is fixed and the other is movable. At least one of the cam surface and the follower element comprise a variable effective shape.

This solution provides for a reliable, easily adjustable breakaway torque of the impact elements. The torque required for the initial several degrees of rotation/tilt of the impact elements (i.e. the break away torque) can be adjusted while the remaining rotation/tilt of the impact elements remains unchanged.

In the conventional art, the breakaway torque can be adjusted by changing a bias of springs or replacing a torsion bar that counteracts the rotation of the cam away from the rest position or by replacing the springs or torsion bars. Such change of bias also affects the restoring force and restoring torque that are applied to return the paddles back to the rest position after an impact. Unlike in the present solution, the breakaway torque and the second part of the torque-curve of the prior art cannot be independently adjusted. In addition, such change of bias requires a force gauge to measure and check the bias and thus leads to higher costs and less efficiencies. Further, depending on the structural connections of the springs and the movable part, the change of spring bias may have little effect on the breakaway torque. Thus, the conventional method of adjusting the breakaway torque may be inappropriate to provide a precise adjustment of the breakaway torque.

In a variant, the variable effective shape comprises at least one of a slope, depth and curvature of at least part of the cam surface of the cam relative to the cam follower. Alternatively or in addition, the variable effective shape of the cam surface is adapted to be varied by setting or adjusting at least one of the slope, depth and curvature before or after the cam follower assembly is installed, and/or during the operation of the cam follower assembly. Alternatively or in addition, the variable effective shape is adapted to be varied by at least one of a modification of a shape and diameter of the follower element of the cam follower relative to the cam before or after the cam follower assembly is installed and/or during the operation of the cam follower assembly.

In a variant, the drivably connected one of the cam and the cam follower is adapted to be connected to the impact element via a shaft supported by at least one bearing. A first bearing can comprise a composite radial spherical plain bearing and/or a second bearing can comprise a composite plain bearing. One or both bearings can preferably be adapted for supporting heavy loads and having good sliding properties. Alternatively or in addition, the second bearing comprises a sleeve bearing adapted to support the shaft. Alternatively or in addition, the first bearing comprises an outer sleeve element and an inner rod or tube element. Alternatively or in addition, one of the outer sleeve element or the inner rod or tube element comprises a layer of low-friction/low maintenance material to contact the other of the outer sleeve element and the inner rod or tube element. This arrangement allows for compensating of an angular deviation during assembly or later during operation. With this bearing arrangement, shaft distortion can be reduced or avoided. This can contribute to a constant smooth operation over time and thus can lead to a constant breakaway torque. Deformations of the shaft caused by impacts or a movement of the rails, the track or the track bed can also be compensated for in this way.

In a variant, the cam follower assembly further comprises a plunger acting as a follower including a follower element and a spring configured to bias the follower element against the cam with a bias force. In a variant, the cam further includes a recess extending a depth from an opening on the curved surface into the cam to an end surface. In a variant, the recess is configured to receive an insert having a concave surface. In a variant, the concave surface is orientated towards the follower element and has a distance from the end surface of the recess. In a variant, the follower/plunger is configured to engage with the cam such that the spring biases the follower element to be in contact with the concave surface when the cam is in a rest position where the recess is aligned with the follower element, and such that a rotation or tilt of the cam away from the rest position moves the follower element against the bias force of the spring.

In comparison with the conventional art of changing bias of springs, the present cam follower assembly allows for independently adjusting the breakaway torque without changing the restoring torque. This possibility of adjustment of the distance aims at no longer requiring a force/torque gauge for measuring the bias of the spring. Further, the adjustment can be done without working against the force of the spring. Therefore, the cam follower assembly according to the present disclosure allows for adjusting the breakaway torque in a fast, low-cost, precise, and high-efficient way.

In a variant the variable longitudinal travel of the follower element relative to the cam surface and/or the cam follower is provided during the first few degrees forming a break away sector of rotation or tilt of the follower element relative to the cam surface by the variable effective shape, upon reception of an impact by the impact element that causes a rotation or tilt from an approximately upright orientation of the impact element in a rest position towards an activated position in which the impact element is in a rotated or tilted orientation of approximately 10 degrees to approximately 45 degrees.

In some variants, the insert may be releasably arranged as effectively forming a part of the cam such that it constitutes and influences the variable effective shape of the cam. The insert can be fixed at a location in the recess according to the desired breakaway torque. This provides a much easier way of achieving a desired breakaway torque compared to changing bias of springs, which requires measuring and checking the bias. Moreover, the insert can be released and then repositioned. The insert may also be replaced by a new, same or differently-shaped insert at the same location. The new insert may also provide a different curvature of the concave surface for a desired breakaway torque. The breakaway torque can thus be changed in a low-cost, precise, and high-efficient way.

In some further variants, the insert may be releasably arranged in the recess and held in its position relative to the follower element in the rest position via a screw, a pin, a clamp, a magnet or the like.

In some variants, the cam may include a hole connecting the end surface to an outer side of the cam opposite to the curved surface. Alternatively or in addition, a position adjustment means extends from the outer side of the cam and through the hole to engage with the insert. The position adjustment means can be configured to adjust the variable effective shape of the cam surface by holding the insert at different locations along the extension of the cam or the depth of the recess.

Thereby, the breakaway torque can be easily adjusted through the position adjustment means without replacing the insert. This further improves the efficiency and reduces costs in adjusting the breakaway torque.

In a variant of the cam follower assembly, the variable longitudinal travel of the follower element relative to the cam is adapted to cause a compression of a spring element provided to urge the follower element of the cam follower against the cam surface of the cam. Alternatively or in addition, the longitudinal travel of the follower element changes as a function of at least one of the tilt and rotation of the cam relative to the cam follower depending on at least one of the slope, depth and curvature of the cam surface relative to the cam follower or at least one of the shape and diameter of the follower element relative to the cam.

In a variant of cam follower assembly a deepest location of the cam surface is at least partially formed by an insert adapted to provide the variable effective shape by changing the shape and/or position of the insert before or after the cam follower assembly is installed and/or during the operation of the cam follower assembly. In other words, the deepest location of the cam surface is the location where spring element of the cam follower is in its least contracted state/the cam follower has its longest longitudinal extension.

In a variant of the cam follower assembly the follower is configured to engage with the cam such that the spring biases the follower element to be in contact with the cam surface when the cam is in a rest position where a deepest location of the cam surface is aligned with the follower element of the cam follower and such that a rotation or tilt of the cam away from the rest position is adapted to move the follower element against the bias force of the spring.

In a variant of the cam follower assembly, the shape and/or position of the insert is configured to be variable to change a breakaway torque required to rotate or tilt the cam away from the rest position towards the activated position. Alternatively or in addition, the insert is releasably arranged at the cam. Alternatively or in addition, the insert is movably and/or releasably held in its position relative to/abutting at the follower element of the cam follower in the rest position.

In a variant of the cam follower assembly, the cam further includes an adjustment means to engage with the insert. Alternatively or in addition, the adjustment means is configured to adjust at least one of the shape, distance, depth, curvature and slope of the cam surface, such that the surface or concave surface of the cam relative to the follower element in the rest position is adapted to change by a distance of approximately 2 to 25 millimeters.

In a variant of the cam follower assembly, the adjustment means includes a pin or screw extending from the outer side of the cam and being configured to adjust at least one of the shape, depth, curvature and slope of the insert by advancing or retracting the insert via an attachment point or thread. Alternatively or in addition, the insert is integrally formed by or with the adjustment means.

In a variant of the cam follower assembly, the insert comprises a bendable plate. Alternatively or in addition, the bendable plate is adapted to be bent so as to form at least a part of the cam surface facing the follower element. Alternatively or in addition, the bendable plate, by its material, dimensions and/or shape provides for adjusting the breakaway torque and the shape of the cam, and hence the torque characteristic of the cam follower assembly. In a variant of the cam follower assembly, the breakaway torque is further determined by a bias force of the spring biasing the follower element against the cam surface in the rest position. Alternatively or in addition, the spring is a compression spring configured to urge the follower element towards the cam surface of the cam.

By advancing the screw into the thread or retracting it from the thread, a part of the screw exposed out of the thread is shortened or lengthened. It is thus possible to change/adjust the breakaway torque in a stepless, continuous manner.

In some variants, the cam follower assembly further comprises an adjustment mechanism configured to adjust the distance of concave surface from the end surface in response to a control signal. The adjustment mechanism may be a piezo actuator, servomotor, a solenoid actuator, or a rotatory solenoid actuator.

The adjustment mechanism thereby allows for remote control of the adjustment, which saves costs and improves efficiencies and safety. In addition, by the remote control, it is made possible to adapt the breakaway torque to a train type or a train speed.

In some variants, the insert may include a bendable plate. The bendable plate is adapted to be bent and have a protrusion received in the recess so as to form the concave surface facing the follower element.

The present disclosure refers also to a dragging equipment detection—DED —system, comprising a rigid mechanical support adapted to be fixed to a train track. In a variant, the impact element is mounted on a shaft and configured to rotate or tilt upon reception of an impact. In a variant a cam follower assembly as described above is included in the DED system. In a variant a sensor is configured to detect a longitudinal travel of the follower element relative to the cam surface of the cam.

In a variant of the dragging equipment detection system one of a sensor activation part and the sensor is attached to the cam follower. In a variant the sensor includes an proximity sensor configured to detect the movement of the follower element relative to the cam in a preferably contactless manner by detecting a movement of the sensor activation part.

In a variant of the dragging equipment detection system the impact element is fixedly mounted on the shaft.

In a variant of the dragging equipment detection system the impact element is configured to rotate/tilt up to±approximately 45 degrees with respect to the longitudinally—preferably upward rest—orientation. In a variant the impact element is adjustable in height via various screw holes in order to achieve a working height of the impact element relative to its rotation or tilt axis.

In a variant of the dragging equipment detection system the sensor is configured to output an alarm when the rotational or tilt movement of the follower element relative to the cam surface exceeds a predetermined angular amount. In a variant the dragging equipment detection system further comprises a camera configured to be directed onto the impact element and output an image of the impact element and/or a dragging equipment to a monitoring unit.

A variant of the dragging equipment detection system further comprises a torsion bar fixed between the rigid mechanical support and the shaft. In a variant the torsion bar is configured to provide a pre-set, increasing resistance against a rotation or tilt motion of the impact element and to provide a resetting torque to the impact element towards its rest position after having been rotated/tilted.

In a variant of the dragging equipment detection system one or both ends of the torsion bar are supported in an elastic material. In a variant one or both ends of the torsion bar are received in a support adapted to provide a reduced resistance against a rotation/tilt movement of the shaft and/or the torsion bar during the initial approximately 5 to 25 degrees of the rotation/tilt movement. In a variant the support adapted to provide a reduced resistance against a rotation comprises a deformable and/or elastic material body, such as rubber block, a spiral spring coil, or the like.

The DED system according to the present disclosure thus allows for independently adjusting the breakaway torque without changing the restoring force. This can be done by adjusting the distance of the concave surface from the end surface and allows for adjusting the breakaway torque in a low-cost, precise, and high-efficient way.

In some variants, a sensor activation part may be attached to the follower element and the sensor may include an inductive proximity sensor configured to detect the movement of the follower element in a contactless manner by detecting a movement of the sensor activation part. The sensor activation part may comprise a ferromagnetic material, such as an iron, steel, cobalt, or nickel plate.

In a further variant, the sensor includes an inductive sensor arrangement with an analogue output such as for example an inductive analogue sensor with IO-Link (II6913, IIK4015A1PKG/IO/US) from ifm electronic Itd. Kingsway Business Park, Oldfield Road, Hampton, Middlesex TW12 2HD, Great Britain. Such an inductive sensor arrangement has three wires to be connected to a control circuit and includes a coil and capacitor which form an LC resonant circuit. If an electrically conductive material target penetrates the sensing field created by the coil, eddy currents are generated in the target, extracting energy from the LC resonant circuit. The sensor ensures that even when a target is in contact with the sensor a process value is provided depending on the distance. Such a sensor arrangement is adapted to determine a distance without physical contact between the object and the target. The standard target is made of mild steel targets, but other metals can be used as well with a respective correction factor. The analog output signal can be a voltage (0 . . . 10 V) or current (4 . . . 20 mA).

The sensor activation part of the DED system may also comprise a lever or gear arrangement to reduce or increase, i.e. adapt the length of the motion of the follower element relative to the sensor. This allows for an appropriate adaption of the sensitivity of the sensor to the motion of the follower element.

In some variants, the impact element may be mounted on the rigid mechanical support via a sleeve bearing (such as a bushing). The sleeve bearing usually is void of rolling elements. Thereby, as compared to a conventional art ball bearing, false brinelling can be avoided, which improves the precision in controlling and adjusting the breakaway torque of the DED system. This sleeve bearing also aims at reducing the maintenance of the DED system. An inevitable hardening of grease in ball or follower element bearings leads to an unstable breakaway torque resulting in an increased maintenance effort to remove hardened grease or adjustment of the cam follower. Moreover, the sleeve bearing suggested here maintains the return force or the DED system at or near a preset level as the bearing does not require any lubricant grease; the latter having the tendency to harden and deteriorate the movability of the inner relative to the outer bearing members.

The sleeve bearing may comprise an outer sleeve element and an inner rod or tube element. One of the outer sleeve element and the inner rod or tube element comprises r a low-friction/low-maintainance resin-enforced glass fiber or Polytetrafluoroethylene—PTFE—or Polyoxymethylene—POM—adapted to contact the other of the outer sleeve element and the inner rod or tube element comprising (stainless) steel contacting with the glass fiber reinforced polyester or Polytetrafluoroethylene bearing element. POM provides good mechanical properties, high dimensional stability and excellent sliding and wear behaviour. POM can be POM homopolymers (POM-H) and POM copolymers (POM-C). POM-H is characterised by an improved strength. PTFE has a coefficient of friction measured against polished steel is 0.1 or less. PTFE has a high melting temperature and exhibits a chemical inertness. The PTFE bearing surface conforms well to the mating (steel) surface.

In some variants, the impact element may be in a vertically upward orientation with respect to the rigid mechanical support when the cam is in the rest position and is configured to rotate or tilt up to a predetermined angle (e.g., up to±approximate 10, 30, 45 or 60 degrees with respect to the vertically upward orientation. It is thus possible to prevent an excessive rotation of the cam, which causes the follower element to break away from the curved surface and become unable to be biased against the cam.

In some variants, the sensor of the cam follower assembly may be configured to output an alarm when the movement of the follower element exceeds a predetermined amount.

In variants where one or both ends of the torsion bar are supported in an elastic material, e.g. rubber, having a lower elasticity module E than the torsion bar, the initial rotation or tilting motion of the impact element of several degrees can be absorbed by the elastic material, so that the adjustable part of the breakaway torque can be further decoupled from the torsion bar.

In some variants, the bearing is protected by a rotatable or twistable (rubber) bellows in addition to and/or as a replacement of a Simmer ring holding the sensor and the cam follower assembly and sealing them against environmental influences. This is possible because the angle of rotation is limited to max. 45° and only a restricted number of rotations take place. Thereby, the DED system would also be water-/flood-proof.

### BRIEF DESCRIPTION OF DRAWINGS

In the drawings, which are not necessarily drawn to scale, like numerals may reference similar components in different figures. The shapes of elements illustrated in the drawings are not intended to limit the variants or the scope of the present disclosure, unless explicitly specified. The drawings illustrate various variants of the present disclosure.

FIG. 1 illustrates an isometric view of a dragging equipment detection system mounted on a train track according to an variant of the present disclosure.

FIG. 2 illustrate a side view of a cam follower assembly according to an variant of the present disclosure.

FIG. 3 illustrates a side view of a cam follower assembly according to another variant of the present disclosure.

FIG. 4 illustrates a side view of a cam follower assembly according to yet another variant of the present disclosure.

FIGS. 5A and FIG. 5B illustrate a cam follower assembly in different states according to yet another variant of the present disclosure.

FIG. 6 illustrates a cam follower assembly for a dragging equipment detection system according to the state of the art.

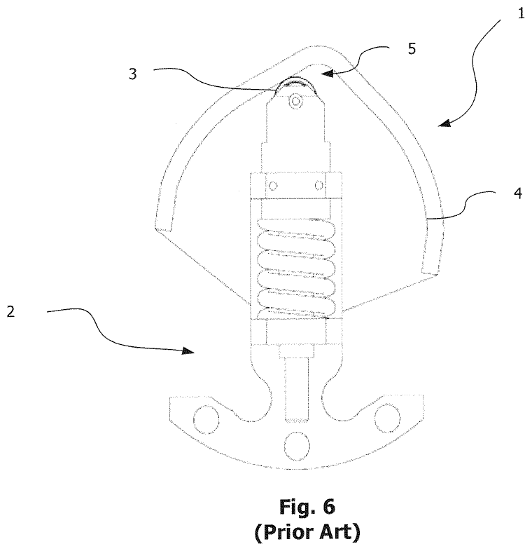

FIG. 7 illustrates a dragging equipment detection system according to yet another variant of the present disclosure in a schematic side view.

### DETAILED DESCRIPTION

The present disclosure provides a cam follower assembly and a dragging equipment detection system including the cam follower assembly. As will be explained in exemplary variants with reference to the figures, the cam follower assembly and the dragging equipment detection system according to the present disclosure provide technical advantages over the conventional art. The variable shape of the cam allows for the breakaway torque required to rotate the cam of the cam follower assembly to be adjusted independently, without changing the restoring force in a low-cost, precise, and high-efficient way. A roller-free bearing may be provided supporting the impact element on the rigid mechanical support. This allows to achieve the synergistic effect of an improved precision in controlling and adjusting the breakaway torque of the DED system and at the same time reducing the maintenance of the DED system. Moreover, the roller-free bearing maintains the return force or the DED system at or near a pre-set level as the bearing does not require any lubricant grease; the latter having the tendency to harden and deteriorate the movability of the inner relative to the outer bearing members.

The present solution provides a low-maintenance and reliable operation of the DED system as it ascertains a long-term reliable low friction motion of the cam relative to the cam follower in both directions.

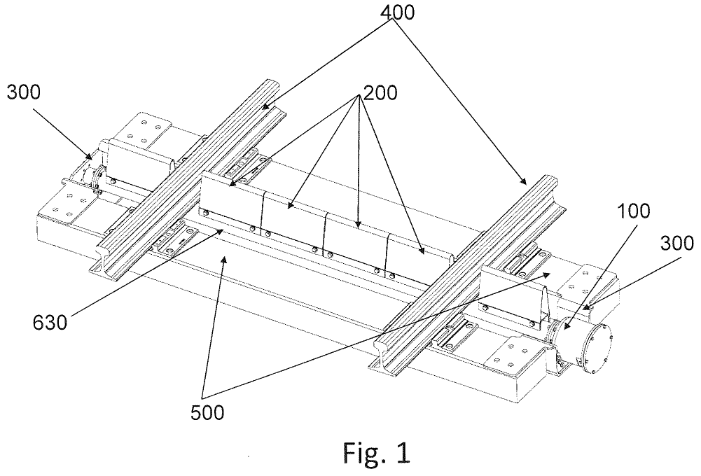

FIG. 1 illustrates a dragging equipment detection system mounted on a train track. The dragging equipment detection system includes a rigid mechanical support 300 that can be fixed to a train track in a direction traversing a train track 400. As show in FIG. 1, the rigid mechanical support 300 may be fixed to the train track between two sleepers 500 (e.g., wood, concrete, or steel sleepers). Alternatively, the rigid mechanical support 300 may be fastened to a sleeper 500 or replace a sleeper 500. An impact element 200 (e.g., a plate, a paddle, or a moveable part) is mounted on the (tubular) shaft 630 and configured to rotate or tilt upon reception of an impact in a direction of the train track 400 (e.g., an impact caused by a part hanging down from a moving train). A cam follower assembly 100 is connected to the shaft 630 for detecting the impact on the impact element 200.

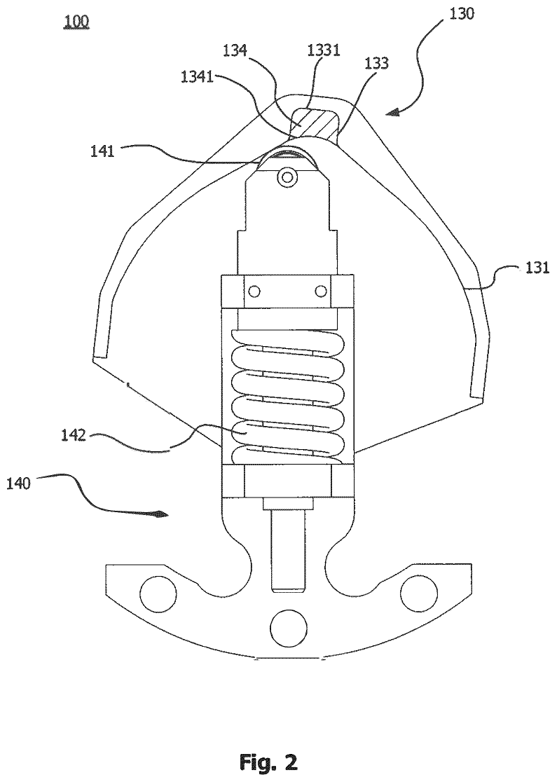

Referring to FIG. 2, where an variant of the cam follower assembly 100 is illustrated, the cam follower assembly 100 includes a cam 130 and a follower 140. In use, with reference to FIG. 1, the cam 130 can be fixed to the impact element 200 of the dragging equipment detection system so as to rotate or tilt together with the impact element 200.

The cam 130 includes a curved surface 131 forming a variable effective shape facing the follower 140 and a recess 133 extending a depth from an opening on the curved surface into the cam 130 to an end surface 1331. Referring to FIG. 2, the cam 130 includes a dome-shaped body surrounding a space by the curved surface 131. The follower 140 is positioned such that a follower element 141 of the follower 140 is in the space and in contact with the curved surface 131.

The recess is configured to receive an insert 134, which has a concave surface 1341 orientated towards the follower element 141 of the follower 140. The concave surface 1341 can be an variant of the variable effective shape arranged at a distance from the end surface 1331 of the recess 133. In the present disclosure, the distance of the concave surface 1341 from the end surface 1331 means a closest distance of the surface 131 from the end surface 1331.

With reference to FIG. 2, the cam rotates due to an impact while the follower remains vertical. In a variant, the cam can be maintained in a fixed vertical orientation while the follower is rotated/tilted due to an impact. The follower 140 includes a follower element 141 and a spring 142. The spring is configured to bias the follower element 141 against the cam 130 and thereby maintain a contact between the follower element 141 and the cam 130. Referring to FIG. 2, the spring is a compression spring configured to push the follower element 141 towards the cam 130 and against the surface 131.

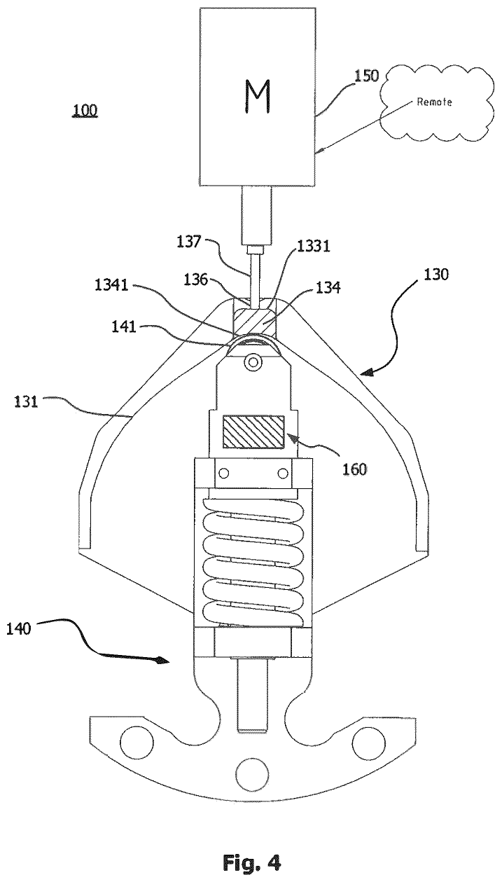

The cam 130 has a rest position (see e.g. FIG. 4), where the recess 133 of the cam 130 aligns with the follower 140 and receives the follower element 141 in the concave surface 1341 of the insert 134. The rest position corresponds to a vertically upward position or orientation of the impact element 200. For example, in the variant of FIG. 1, the vertically upward position or orientation is in a direction perpendicular to the ground and the rigid mechanical support 300.

The cam 130, particularly the curved surface 131 with the insert of variable effective shape, is arranged to rotate or tilt in a predetermined trajectory upon reception of an impact in the train rail direction. Since the spring 142 biases the follower element 141 against the cam 130, a rotation or tilt of the cam 130 away from the rest position has to overcome a breakaway torque before the cam 130 can break away from the concave surface 1341 of the insert 134. With reference to FIG. 2, when the cam 130 rotates or tilts due to an impact to move out of the rest position in response to an impact in the train rail direction, the concave surface 1341 and the curved surface 131 of variable effective shape push the follower element 141 towards the spring 142. The further the cam is rotated or tilted away from the rest position, the more is the follower element 141 moved against the bias of the spring 142. Namely, the rotation or tilt of the cam 130 away from the rest position pushes the follower element 141 towards the spring 142.

The cam follower or follower 140 and the cam 130 are thus configured to engage with each other such that the spring 142 biases the follower element 141 to be received in the concave surface 1341 when the cam 130 is in the rest position and such that a rotation or tilt of the cam 130 away from the rest position moves the follower element 141 against the bias force of the spring 142. When rotating away from the rest position, the cam 130 presses the follower element 141 towards the spring 142 so that the follower element 141 can move out of the concave surface 1331 (as illustrated in FIG. 2). That is, a breakaway torque is required to rotate or tilt the cam 130 so that the follower element 141 can move out of the concave surface 1341 and so that the cam 130 can be moved away from the rest position. Here, the rest position is a position of the cam 130 relative to the follower element 141 where the recess 133 is aligned with the follower element 141 and the follower element 141 is received in the concave surface 1341 before the cam 130 is rotated or tilted to the state in FIG. 2. In the variant illustrated in FIG. 2, the spring 142 has a greatest length when the follower element 141 is in contact with the curved surface 131 since the follower element 141 is received in the concave surface 1341.

In order that the cam 130 can be returned to the rest position, the follower 140 and the cam 130 may be further configured to engage with each other such that the spring 142 biases the follower element 141 against the curved surface 131 so as to return the cam 130 to the rest position after the cam 130 is moved out of the rest position. Specifically, the curved surface 131 of variable effective shape and the spring 142 may be configured such that the further the cam 130 rotates or tilts away from the rest position, the greater is the bias force of the spring 142 biasing the follower element 141 against the curved surface 131. Thereby, the spring 142 provides a restoring force for biasing the cam 130 back to the rest position. When the follower element 141 is moved against the bias force of the spring by the rotation or tilt of the cam 130, a sensor (not shown) may be configured to detect a movement of the follower element. The sensor may be further configured to detect whether a movement amount of the follower element 141 exceeds a predetermined amount, which reflects whether an impact received by the impact element 200 exceeds a threshold.

The sensor can be a mechanical or electronic switch, which is turned on and off in response to the movement of the follower element 141. Alternatively, the sensor can provide a digital or an analog signal. As illustrated in FIG. 2, a sensor activation part 160 may be attached to the follower element 141 moving together with the follower element 141 and the sensor may be an inductive proximity sensor configured to detect a movement of the sensor activation part 160. Specifically, the inductive proximity sensor (not shown in the side view of FIG. 2) may be positioned near the sensor activation part 160 at a side of the follower 140 (e.g., a side facing the side view of FIG. 2) and configured to generate a current of 4 to 20 mA in response to the movement of the sensor activation part 160.

A gear or lever arrangement between the sensor activation part 160 and the sensor can be provided to optimally adapt the motion of the activation part to the sensor. The sensor activation part 160 may comprise a material (such as ferromagnetic materials made of at least one selected rom iron, cobalt, and nickel) that can affect a magnetic field by a movement of the sensor activation part 160. The inductive proximity sensor may be configured cause a magnetic field, the change of which is sensed by the inductive proximity sensor. In the variant of FIG. 2, the sensor activation part 160 may be an iron, nickel, steel or cobalt plate. Other types of sensors, such as capacitive or optical sensors and corresponding sensor activation parts suitable for detecting a movement of the follower element may also be used. The sensor and its activation part are not specific to the various embodiments disclosed in the different Figs.

Referring again to FIG. 2, the cam 130 provides for a variable shape in that it includes the insert 134 of variable effective shape received and held in the recess 133. The insert 134 may be a metal part. The insert 134 has a concave surface 1341 at a distance from the end surface 1331 of the recess 133. The concave surface 1341 is orientated towards the follower element 141 and configured to receive the follower element 141 when the cam 130 is in the rest position. The concave surface 1341 is configured to determine the breakaway torque required to rotate the cam 130 away from the rest position by its distance from the end surface 1331, which depends on the location of the insert held in the recess and the curvature of the concave surface as will be described below.

When the concave surface 1341 has a greater distance from the end surface 1331, a smaller breakaway torque is required to move the cam 130 away from the rest position (i.e., move the follower element out of the concave surface 1341). When a distance of the concave surface 1341 from the end surface 1331 is smaller, the follower element 141 has to overcome a greater breakaway torque to move the cam 130 away from the rest position. To explain further, referring to FIG. 2, when the cam 130 is in the rest position, the concave surface 1341 receives the follower element 141 such that the spring 142 is extended to a greatest length and has a smallest bias force biasing the follower element 141 against the cam 130. Accordingly, when the cam has a concave surface 1341 closer to the end surface 1331 in the rest position, the spring 142 extends further and thus a displacement of the spring required to move the cam 130 from the rest position to a position contacting the follower element 141 by the curved surface 131 becomes greater, which means that a greater breakaway torque is required.

To have a smooth transition between the recessed surface 1341 and the curved surface 131, the curved surface 131 may be chamfered or rounded at the edge adjacent to the recess 133. Thereby, the cam 130 can be moved out of the rest position while having a different distance of the concave surface 1341 from the end surface 1331.

Turning back to FIG. 2, in this variant, the insert 134 of variable effective shape is releasably fixed to the recess 133, for example, by a screw fixing the insert 134 to the end surface 1331 of the recess 133 and is thus replaceable. A user can thus obtain a desired breakaway torque by simply selecting and installing a desired insert 134, for example, an insert 134 having a desired height so as to form a concave surface 1341 with a desired distance from the end surface 1331.

When changing the insert 134, the cam 130 can be slightly rotated or tilted away from the rest position as shown in FIG. 2, for example, by moving the impact element 200. Thus, the insert 134 can be easily removed and a new insert 134 can be easily installed without working against the spring force of the spring 142.

The cam follower assembly 100 allows for adjusting a breakaway torque independently without changing the bias of the spring 142 or the restoring force applied by the spring 142 to the curved surface 131 of variable effective shape when the cam 130 is away from the rest position and the follower element 141 is out of the concave surface 1341 (since the adjustment is made by changing only the concave surface 1341).

In the conventional art, the breakaway torque is adjusted by changing a bias of the spring and/or a bias of a torsion bar, which requires checking the bias by a force gauge and thus takes more time and costs. Further, the adjustment may be affected by the structural connection between spring and the cam. In contrast, the cam follower assembly 100 according to the present disclosure allows for adjusting the breakaway torque by simply selecting a desired insert 134 with a desired height for a desired distance from the end surface 1331 depending on the desired breakaway torque. Thus, compared to the conventional methods, the cam follower assembly 100 and the dragging equipment detection system according to the present disclosure thus allows for adjusting the breakaway torque in a low-cost, efficient, and precise way.

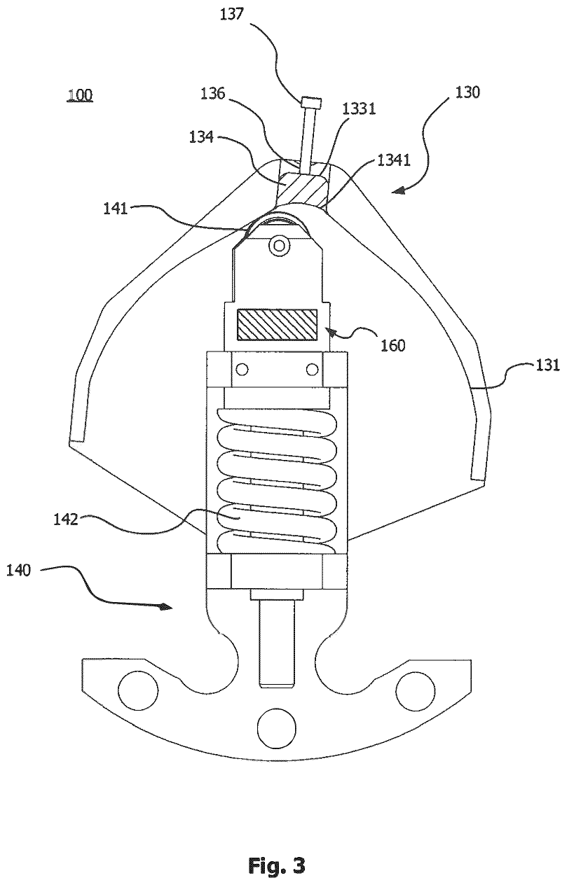

FIG. 3 illustrates a cam follower assembly 100 according to another variant. The same reference numerals of FIG. 2 are used to designate the same or similar elements in FIG. 3. The cam follower assembly of FIG. 3 differs from that of FIG. 2 in that the cam 130 further includes a hole 136 and a position adjustment means 137. The hole 136 connects the end surface 1331 to the outer side of the cam 130, which is opposite to the curved surface 131. The position adjustment means 137 extends from the outer side of the cam through the hole 136 to engage with the insert 134 and is configured to hold the insert 134 at different locations along the depth of the recess 133 and thereby adjust the distance of the concave surface 1341 from the end surface 1331. In a variant, a pretension could also be effected on the insert 134 with a spring towards the curved surface 131 and/or place distance chips behind the insert. In a further variant, a grooves and wedge arrangement could be used to change the position between the insert 134 and the curved surface 131.

Referring to FIG. 3, as illustrated in this variant, the position adjustment means 137 includes a screw that extends from the outer side of the cam through the hole 136 to engage with a thread of the insert 134. As a result, the distance of the insert 134 from the hole 136 and the distance of the concave surface 1341 can be changed by advancing the screw into the thread or retracting the screw from the thread. When advancing the screw into the thread, the length of the screw exposed outside of the thread is shortened, which shortens the distance of the insert 134 from the hole 136 and shortens the distance of the concave surface 1341 from the end surface 1331. When retracting the screw from the thread, the length of the screw exposed outside of the thread is increased, which increases the distance of the insert 134 from the hole 136 and increase the distance of the concave surface 1341 from the end surface 1331.

When adjusting the distance of the insert 134 from the hole 136, the cam 130 can be slightly rotated or tilted away from the rest position as shown in FIG. 3, for example, by moving the impact element 200. Then, the position of the insert and the distance of the concave surface 1341 from the end surface 1331 can be easily changed without working against the spring force of the spring 142.

As explained above, the cam follower assembly of FIG. 3 allows for a stepless adjustment of the distance of the concave surface 1341 from the end surface 1331 and thus a stepless adjustment of the breakaway torque. This further facilitates a define adjustment of the breakaway torque and reduces the costs of preparing multiple replaceable inserts.

FIG. 4 illustrates a cam follower assembly according to another variant. The same reference numerals of FIG. 3 are used to designate the same or similar elements in FIG. 4.

The cam follower assembly of FIG. 4 differs from that of FIG. 3 in that an adjustment mechanism 150 is further provided to, in response to a received control signal, actuate the position adjustment means 137 to adjust the distance of the concave surface 1341 from the end surface 1331 of the recess 133. The adjustment mechanism 150 may be a piezo actuator, a servomotor, a solenoid actuator, or a rotatory solenoid actuator.

The cam follower assembly of FIG. 4 thus allows for a remote control of the adjustment of the breakaway torque. This saves costs and improves efficiencies and safety. In particular, the remote control allows for changing the breakaway torque in the range of less than one second. In addition, by the remote control, it is made possible to adapt the breakaway torque to a train type or a train speed.

The variable shape may be obtained by the insert 134 of variable effective shape having a surface 1341 with a curvature for a distance of the concave surface 1341 from the end surface 1331 when the insert 134 is at the same location along the depth in the recess 133. Specifically, a shape/curvature of the concave surface 1341 may determine a height between the concave surface 1341 and the side opposite to the concave surface, which also determine a distance of the concave surface 1341 from the end surface 1331 when the insert 134 is at the same location along the depth of the recess. Therefore, an insert 134 with a desired shape/dimension/curvature may be used to provide a desired breakaway torque.

For achieving an appropriate breakaway torque, an insert of variable effective shape having a suitable shape/dimension/curvature of the surface may then be selected and installed in the recess (as described with reference to FIG. 2) or may be positioned by a position adjustment means 137 (as described with reference to FIG. 3) and an adjustment mechanism 150 (as described with reference to FIG. 4).

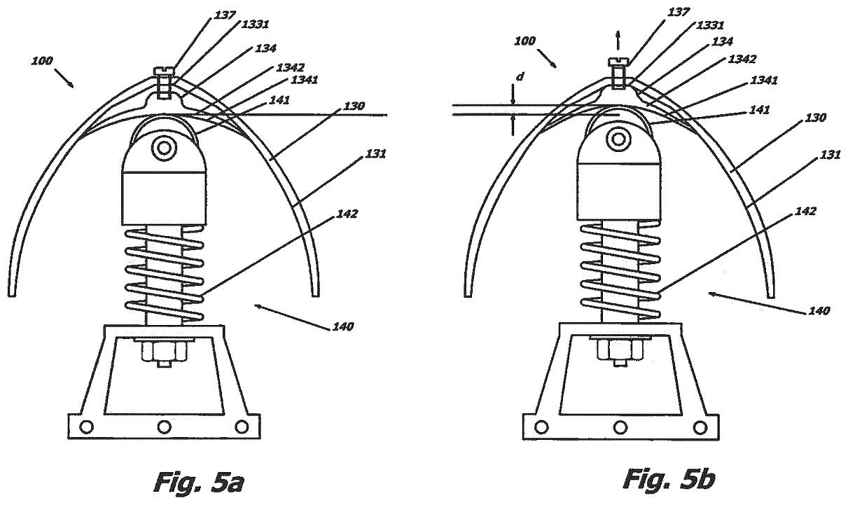

FIG. 5A and FIG. 5B illustrate a cam follower assembly according to another variant, in which the insert 134 includes a bendable plate 1342 for providing an adjustable curvature of the concave surface 1341.

The bendable plate 1342, formed, e.g., of spring steel, has a length greater than a width of the recess 133. As shown in FIG. 5A and FIG. 5B, the bendable plate 1342 can be bent into different states/degrees and has a protrusion received in the recess 133 such that a surface of the bendable plate 1342 forms the concave surface 1341 as described above. For achieving a desired breakaway torque, a bendable plate 1342 having a suitable length can thus be selected and installed in the cam 130. Further, by including the position adjustment means 137 as described with reference to FIG. 3, the bendable plate 1342 of FIG. 5 can then be held at different locations by receiving holding the protrusion at different locations. This allows for adjusting the shape, curvature or distance of the concave surface 1341 from the end surface 1331.

In FIG. 5A, the bendable plate 1342 is held at a location where the protrusion of the bendable plate 1342 is farther away from the end surface 1331 than the location in FIG. 5B. When changing the bendable plate 1342 from the state in FIG. 5A to the state in FIG. 5B (by the position adjustment means 137 as described with reference to FIG. 3), the bendable plate 1342 is bent further and has a greater curvature (i.e., smaller radius of curvature). As a result, a distance of the concave surface 1341 from the end surface 1331 in FIG. 5B is smaller than that in FIG. 5A. Thus, a greater breakaway torque can be achieved by changing the location of insert 134 in FIG. 5A to the location of the insert 134 in FIG. 5B.

Instead of having the position adjustment means 137 as illustrated in FIG. 5A and FIG. 5B, the insert 134 having a bendable plate 1342 may be releasably arranged in the recess and held in its position relative to the follower element in the rest position (for example, via a screw) as described with reference to FIG. 2.

While it is described above that the breakaway torque is determined by a depth or shape of the recessed surface of the insert, it goes without saying that a bias of the spring (particularly, a force of the spring pushing the follower element against the cam at the rest position) and other factors (such as a diameter of the follower element, a bias of a torsion bar 280) would also affect the breakaway torque and may be taken into account when adjusting the breakaway torque. The spring 142 and the torsion bar 280 may be further configured to provide a restoring momentum or force for returning the cam to the rest position. The diameter of the follower element 141 influences the adjustment. The follower element 141 may therefore also to be understood as part of the adjustment mechanism. The torsion bar 280 is independent from the follower element and other adjustment components and not adjustable. The torsional momentum of the torsion bar 280 against twisting should be dimensioned so as to ensure a sufficient restoring torque with the follower element on the cam surface 131.

Referring back to FIG. 1, a dragging detection system according to an variant of the present disclosure includes a rigid mechanism support 300, an impact element 200 mounted on the rigid mechanical support 300, and an cam follower assembly 100 as described above. Further, the dragging detection system includes a sensor configured to detect whether a movement of the follower element in response to a rotation or tilt of the cam 130 away from the rest position. This sensor can be configured to be redundant and have a fail safe logic.

In one variant, the sensor may include an inductive, capacitive or laser distance activated proximity sensor configured to detect a movement amount of the follower element in a contactless way as mentioned above. Specifically, a sensor activation part (e.g., an iron plate) may be attached to a part of the follower (e.g., the rod holding the follower element) to move together with the follower element. The inductive proximity sensor may be configured to detect a movement of the follower element by detecting a movement of the sensor activation part based on the interaction between the sensor activation part and a magnetic field generated by the inductive proximity sensor. In another variant, the sensor may be a switch configured to be closed and opened in response to a movement of the follower element.

In response to detection of a movement of the follower element (e.g., a movement amount of the follower element being greater than a predetermined amount), the sensor of the dragging equipment detection system can output an alarm. Alternatively or additionally, the sensor may output, to a monitoring device, a signal indicating the movement of the follower element. The monitoring device can then output an alarm when a movement amount of the follower element being greater than a predetermined amount. Here, an alarm can be an audio alarm and/or a visual alarm indicating an alert of an impact on the impact element of the dragging equipment detection system. Thereby, an operator can be provided with an alert and notified of the impact and perform necessary operations to correct the defect that causes the impact. In an example, the defect may be a clutch chain or hydraulic tubes handing down from a moving train. Being notified of an impact caused by the clutch chain or pneumatic tubes by the dragging equipment detection system, an operator can then stop the train remove the objects hanging from the train before further damage is caused. The DED system can also trigger a camera to provide an image of the cause that triggered the DED system.

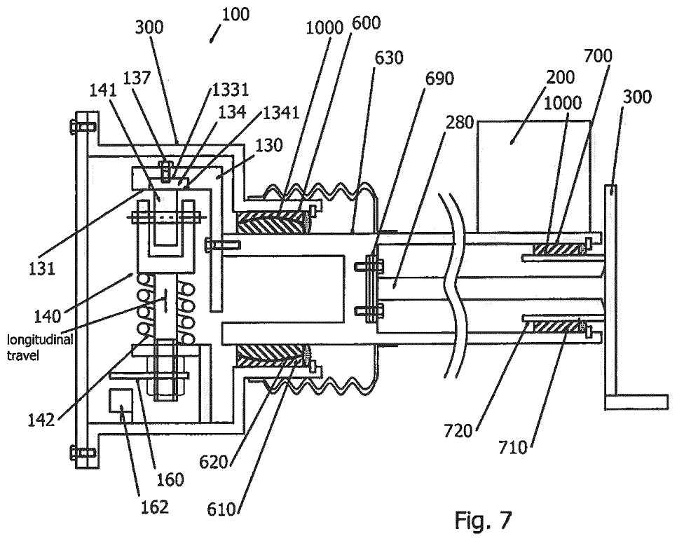

The impact element 200, as illustrated in FIG. 1 or 7, includes multiple sections mounted, via a rotatable/tiltable shaft 630, on the rigid mechanical support 300, which are fixed on the train track under the train rails 400. In the prior art, the impact element 200 is mounted on a rigid mechanical support 300 via ball bearing. To avoid false brinelling, which usually develops due to vibration in a non-rotating state, the impact element 200 may be mounted on a rigid mechanical support 300 via a sleeve bearing.

As shown in FIG. 7, the cam 130 is the drivably connected to the impact element 200 via a shaft 630 supported by two bearings 600, 700. In the present variant, both bearings 600, 700 are adapted for supporting heavy loads and have good sliding properties. A first bearing 600 comprises a composite radial spherical plain bearing 610, 620 mounted in the rigid mechanical support 300 to support one end of the shaft 630 (in FIG. 7 the left end).

A second bearing 700 comprises a composite plain bearing 710, 720 mounted in the rigid mechanical support 300 to support the other end of the shaft 630 (in FIG. 7 the right end). The second bearing 700 comprises a sleeve bearing adapted to support the shaft 630. In particular, the first bearing 700 comprises an outer sleeve element 710 and an inner rod or tube element 720. In the present variant, the outer sleeve element 710 comprises a layer of low-friction/low maintenance material to contact the the inner rod or tube element 720. Specifically, the inner and the outer sleeve elements 620, 610 comprise a tube of Polytetrafluoroethylene. By using a sleeve bearing, it is possible to avoid the false brinelling effect and thus improve the precision and efficiency in controlling and adjusting the breakaway torque. The tube element 720 is rigidly fixed to the rigid mechanical support 300. The latter also fixedly supports the other end of the torsion bar 280. The sleeve bearing element 710 engages rotatably with the shaft tube 720 and is also made of Polytetrafluoroethylene.

In a non-impact state, the impact element 200 is arranged to be in a vertically upward orientation with respect to the rigid mechanical support and the ground for receiving an impact when a part hanging down from a moving train moves across the dragging equipment detection system. The impact element 200 rotates or tilts in a direction when receiving an impact. The rotation of the impact element 200 is limited to a predetermined degree (e.g., up to +/−15, 30 or 45 degrees). This can prevent the cam from rotating excessively and the follower element from escaping from the curved surface of the cam, which may cause the follower element to become unable to be biased by the spring against the cam.

The above variants are not intended to limit the scope of the present disclosure. Rather, the present disclosure covers various modifications based on the features disclosed herein, such as a combination of two or more features described above in different variants or removal of a feature from a variant, within the scope of the present disclosure. For example, the variant illustrated in FIG. 5A and 5B may further include the adjustment mechanism 137 as described with reference to FIG. 4 or the sensor activation part 160 as described with reference to FIG. 2. On the other hand, the features of the disclosure are not limited to the described specific variants. For example, while the variants illustrate a follower element configured to move closer to a compression spring in response to a rotation or tilt of the cam, the follower element may be configured to move away from an extension spring in response to a rotation or tilt of the cam. A cam follower assembly may include different configurations of the cam and the follower while achieving the same functions of transforming a rotation or tilt of the cam into a movement of the follower. The insert and the recess according to the present disclosure may be applied to such different configurations of the cam and the follower, rather than being limited to those disclosed by the specific variants.

As shown in FIG. 7, the dragging equipment detection system 100 further includes a torsion bar 280 fixed between the rigid mechanical support 300 and the shaft, wherein the torsion bar is configured to provide a bias torque against a rotation or tilt of the impact element away from the vertically upward orientation. The breakaway torque may be further determined also by the bias torque of the torsion bar. In some variants, the torsion bar attachment point is supported in an elastic material, e.g. rubber. Thereby, the initial rotation motion of the shaft by several degrees (e.g. 5 to 15 degrees) can be absorbed by the elastic material. This further decouples the adjustable part of the breakaway torque from the torsion bar.

In some variants, the bearing is protected by a rotating bellows in addition to and/or as a replacement of a Simmer ring holding the sensor and the cam follower assembly and sealing them against environmental influences. This is possible because the angle of rotation is limited to max. 45° and only a restricted number of rotations take place. Thereby, the DED system would also be water-/flood-proof.

The above describes some aspects or elements of the cam follower assembly and the dragging equipment detection system, with which the present disclosure is concerned. Other aspects or elements (such as fixation of the follower on the track, fixation of the cam with respect to the follower, or mounting of the rigid mechanical support and the impact element) for variant of the cam follower assembly and the dragging equipment detection system are possible.

The variants described above are merely intended to provide a better understanding of the structure, the mode of operation and the properties; they do not limit the disclosure to the variants. The Figs. are partly schematic, with essential properties and effects being shown partly enlarged in order to clarify the functions, operating principles, technical concepts and features. In this context, each mode of operation, each principle, each technical concept and each feature disclosed in the Figs. or in the text can be combined with all claims, each feature in the text and in the other Figs, other functionalities, principles, technical features and characteristics contained in or resulting from this disclosure, so that all conceivable combinations can be attributed to the described solutions. Combinations between all individual variants in the text, i.e. in each section of the description, in the claims and also combinations between different variants in the text, in the claims and in the Figs. are also included.

Also, the claims do not limit the disclosure and thus the combination possibilities of all disclosed features among each other. All disclosed features are explicitly disclosed both individually and in combination with all other in conjunction or individually features herein. Many other effective alternatives are possible. It will be understood that the solution is not limited to the described variants and encompasses modifications and lies within the scope of the claims appended hereto.

1. A cam follower assembly for a dragging equipment detection system comprising:
one of a cam or a cam follower adapted to be drivably connected to an impact element of a dragging equipment detection system so as to move together with the impact element upon reception of an impact; wherein
the cam includes a cam surface; and wherein
the cam follower includes a follower element and a spring configured to bias the follower element against the cam surface of the cam with a bias force; wherein
the cam follower and the cam are adapted to move relative to each other, while one of the cam follower and the cam is fixed and the other is movable; and wherein
at least one of the cam surface and the follower element comprise a variable effective shape,
wherein a deepest location of the cam surface is at least partially formed by an insert adapted to provide the variable effective shape by changing the shape and/or position of the insert before or after the cam follower assembly is installed and/or during the operation of the cam follower assembly.

2. The cam follower assembly of claim 1, wherein the variable effective shape comprises at least one of a slope, depth and curvature of at least part of the cam surface of the cam relative to the cam follower and/or wherein the variable effective shape of the cam surface being adapted to be varied by setting or adjusting at least one of the slope, depth and curvature before or after the cam follower assembly is installed; and/or during the operation of the cam follower assembly; and/or
the variable effective shape is adapted to be varied by at least one of a modification of a shape and diameter of the follower element of the cam follower relative to the cam before or after the cam follower assembly is installed and/or during the operation of the cam follower assembly.

3. The cam follower assembly of claim 1, wherein the drivably connected one of the cam and the cam follower is adapted to be connected to the impact element via a shaft supported by at least one bearing; wherein
a first bearing comprises a composite radial spherical plain bearing and/or a second bearing comprises a composite plain bearing, wherein one or both bearings preferably being adapted for supporting heavy loads and having good sliding properties; and/or wherein
the second bearing comprises a sleeve bearing adapted to support the shaft; and/or wherein
the first bearing comprises an outer sleeve element and an inner rod or tube element; and/or wherein
one of the outer sleeve element or the inner rod or tube element comprises a layer of low-friction/low maintenance material to contact the other of the outer sleeve element and the inner rod or tube element.

4. The cam follower assembly of claim 1, wherein a variable longitudinal travel of the follower element relative to the cam surface and/or the cam follower is provided during the first few degrees forming a break away sector of rotation or tilt of the follower element relative to the cam surface by the variable effective shape, upon reception of an impact by the impact element that causes a rotation or tilt from an approximately upright orientation of the impact element in a rest position towards an activated position in which the impact element is in a rotated or tilted orientation of approximately 10 degrees to approximately 45 degrees.

5. The cam follower assembly of claim 4, wherein the variable longitudinal travel of the follower element relative to the cam is adapted to cause a compression of a spring element which is provided to urge the follower element of the cam follower against the cam surface of the cam; and/or wherein
the longitudinal travel of the follower element changes as a function of at least one of the tilt and rotation of the cam relative to the cam follower depending on at least one of the slope, depth and curvature of the cam surface relative to the cam follower or at least one of the shape and diameter of the follower element relative to the cam.

6. (canceled)

7. The cam follower assembly of claim 1, wherein the follower is configured to engage with the cam such that the spring biases the follower element to be in contact with the cam surface when the cam is in a rest position where a deepest location of the cam surface is aligned with the follower element of the cam follower and such that a rotation or tilt of the cam away from the rest position moves the follower element against the bias force of the spring.

8. The cam follower assembly of claim 1, wherein the shape and/or position of the insert is configured to be variable to change a breakaway torque required to rotate or tilt the cam away from the rest position towards the activated position; and/or wherein
the insert is releasably arranged at the cam; and/or wherein the insert is movably and/or releasably held in its position relative to/abutting at the follower element of the cam follower in the rest position.

9. The cam follower assembly of claim 1, wherein the cam further includes an adjustment means to engage with the insert, wherein the adjustment means is configured to adjust at least one of the shape, distance, depth, curvature and slope of the cam surface, such that the surface or concave surface of the cam relative to the follower element in the rest position is adapted to change by a distance d of approximately 2 to 25 millimeters.

10. The cam follower assembly of claim 1, wherein the adjustment means includes a pin or screw extending from the outer side of the cam and being configured to adjust at least one of the shape, depth, curvature and slope of the insert by advancing or retracting the insert via an attachment point or thread, and/or wherein
the insert is integrally formed by the adjustment means.

11. The cam follower assembly of claim 1, further comprising an adjustment mechanism configured to receive a control signal and actuate the position adjustment means in response to the control signal; and/or wherein the adjustment mechanism is a piezo actuator, a servomotor, a solenoid actuator, or a rotatory solenoid actuator.

12. The cam follower assembly of claim 1, wherein the insert comprises a bendable plate, wherein the bendable plate is adapted to be bent so as to form at least a part of the cam surface facing the follower element, and/or wherein
the bendable plate, by its material, dimensions and shape provides for adjusting the breakaway torque and the shape of the cam, and hence the torque characteristic of the cam follower assembly.

13. The cam follower assembly of claim 1, wherein the breakaway torque is further determined by a bias force of the spring biasing the follower element against the cam surface in the rest position, and/or wherein
the spring is a compression spring configured to urge the follower element towards the cam surface of the cam.

14. A dragging equipment detection system, comprising
a rigid mechanical support adapted to be fixed to a train track;
an impact element mounted on a shaft and configured to rotate or tilt upon reception of an impact;
a cam follower assembly according to claim 1; and
a sensor configured to detect a longitudinal travel of the follower element relative to the cam surface of the cam.

15. The dragging equipment detection system of claim 13, wherein one of a sensor activation part and the sensor is attached to the cam follower; and the sensor includes an proximity sensor configured to detect the movement of the follower element relative to the cam in a contactless manner by detecting a movement of the sensor activation part.

16. The dragging equipment detection system of claim 13, wherein the impact element is fixedly mounted on the shaft.

17. The dragging equipment detection system of claim 13, wherein the impact element is configured to rotate/tilt up to ±approximately 45 degrees with respect to the longitudinally upward orientation, and/or wherein the impact element is adjustable in height via various screw holes in order to achieve a working height of the impact element relative to its rotation or tilt axis.

18. The dragging equipment detection system of any of claims claim 13, wherein the sensor is configured to output an alarm when the rotational or tilt movement of the follower element relative to the cam surface exceeds a predetermined angular amount; and/or wherein
the dragging equipment detection system further comprising a camera configured to be directed onto the impact element and output an image of the impact element and/or a dragging equipment to a monitoring unit.

19. The dragging equipment detection system of claim 13, further comprising a torsion bar fixed between the rigid mechanical support and the shaft; and/or wherein
the torsion bar is configured to provide a pre-set, increasing resistance against a rotation or tilt motion of the impact element and to provide a resetting torque to the impact element towards its rest position after having been rotated/tilted.

20. The dragging equipment detection system of claim 18, wherein one or both ends of the torsion bar are supported in an elastic material; and/or wherein
one or both ends of the torsion bar are received in a support adapted to provide a reduced and/or retarded resistance against a rotation/tilt movement of the shaft during the initial approximately 5 to 25 degrees of the rotation/tilt movement, and/or wherein
the support adapted to provide a reduced and/or retarded resistance against a rotation comprises a deformable and/or elastic material body, such as rubber block, a spiral spring coil, or the like.
